(19) United States
(12) Patent Application Publication
(10) Pub. No.: US 2017/0243196 A1
(43) Pub. Date: Aug. 24, 2017

(54) Business Gift Card

(71) Applicants: Calvin Wiese, Altamonte Springs, FL (US); Cecil Wiese, Altamonte Springs, FL (US); Corbin Wiese, Altamonte Springs, FL (US)

(72) Inventors: Calvin Wiese, Altamonte Springs, FL (US); Cecil Wiese, Altamonte Springs, FL (US); Corbin Wiese, Altamonte Springs, FL (US)

(21) Appl. No.: 15/048,230

(22) Filed: Feb. 19, 2016

(51) Int. Cl. G06Q 20/34

(52) U.S. Cl. CPC G06Q 20/342; G06Q 20/348

(57) ABSTRACT

A combination business card and gift card with a coded information portion is provided to be sold and delivered to a recipient as a unit. The business gift card includes contact information along with graphics or logos. The business gift card also preferably includes a scannable encoded portion which, when an account in a remote computer corresponding to the encoded information is activated, enables the holder of the business gift card to obtain goods or services by access to credit corresponding to a gift card or SVC (stored value card) account from a remote database.

### BACKGROUND OF THE INVENTION

1. Field of the Invention

This invention relates generally to business cards which include encoded gift card or SVC information which may be redeemed for goods or services. More particularly, it is concerned with a business card having encoded information in the form of an optically or magnetically scannable region which may be activated at the time of purchase whereby the recipient of the business card may use the card to purchase merchandise or services.

2. Description of the Related Art

In both business and daily life, the need to identify oneself and provide a means of communication between individuals and organizations has always been an important affair. To meet this need, various methods, such as business cards, rolodexes, and a plethora of digital contact information packets have been utilized. Surprisingly, even in the digitally connected age, nothing has been more prominent or prolific in the area of communicating contact information as the business card.

Business cards perform a simple function: they efficiently display one's contact information including name, title, phone number, fax number, website URL, and/or email address typically printed on a 3.5″ by 2″ paper card. In many social settings the exchange of business cards has become a ritual whenever people first meet. Particularly in the business world, the exchange of business cards is the first step in a professional relationship which may lead to the provision or exchange of goods or services.

In order to gain a competitive business advantage, many people and organizations seek to differentiate their business cards. A unique business card, or a business card which projects the values of a person or organization has become an important piece of marketing and sales strategies. Because of this trend, business cards can be found in various colors, shapes and materials. Furthermore, business cards often incorporate printing features such as embossing, plating and the addition of barcodes and/or QR codes which, when scanned by an appropriate device, lead to websites and other digital content.

### SUMMARY OF THE INVENTION

The present invention provides a novel solution to address the needs of organizations and persons to distribute unique and differentiated business cards by including a gift card, or SVC, account identifier on a business card. The business card includes encoded gift card or SVC account information in the form of a optically or magnetically scannable region. Gift card or SVC account information is coupled to the business card and thereby purchased as a unit to include both the business card and gift card or SVC. The resulting combination provides the purchaser of the business card with additional attention to the business card than would otherwise be afforded from the recipient.

### BRIEF DESCRIPTION OF THE DRAWINGS

FIG. 1 is a front elevation view of the business gift card with contact information and logo of the gift card source.

FIG. 2 is a rear elevational view of the business gift card with an encoded scannable region; instructions of how to use the card, along with a legal disclaimer is also shown.

### DETAILED DESCRIPTION

A business gift card is created by printing a business card on card stock as typically done. The gift portion is added to the business card by affixing a code corresponding with a stored value account.

A gift card or stored value card may be purchased and activated from a desired vendor; such as Starbucks, AMC Theaters, or Taco Bell. Most gift cards or SVCs contain account identification information on the card; typically in the form of a barcode or magnetic strip. Utilizing an appropriate electronic device, the encoded account information from the gift card is deciphered.

Using a computer, the encoded account information from the gift card is reproduced and affixed or printed on the business gift card.

### EXAMPLE

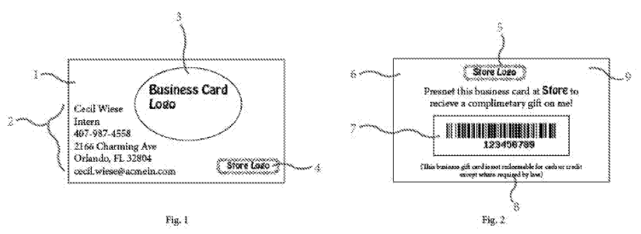

By way of a non-limiting example, FIG. 1 illustrates an exemplary embodiment of the present invention. Referring to FIG. 1 the front side of a 3.5″×2″ paper card is printed with an individual's name, title, mailing address, email address and phone number 2. This side of the card may also include a business logo 3 or other graphics. Also, on this side of the card a logo correlating to the organization or business where the business card is usable to purchase goods or services 4 may be included.

On the other side of this card, as shown in FIG. 2, a barcode 7 is printed which is readily readable by a point-of-sale terminal, account access station, kiosk, or other suitable device. This barcode 7 contains the account number from a gift card purchased from a popular retailer. This side of the card may also include the graphics or logo corresponding to this retailer 5, instructions or a personalized message pertaining to how to use the business gift card 9, and any legal disclaimer which may be required to accompany gift cards dependent on local laws 8. This business card can be used to redeem goods and services from the gift card originating retailer when physically presented to this retailer.

We claim:

1. A method for creating business gift cards comprising;
a) creating a business card,
b) affixing a code to the business card that corresponds with a stored value account

2. The business gift card of claim 1 where the affixed code is a bar code.

3. The business gift card of claim 1 where the affixed code is a magnetic strip.

4. The business gift card of claim 1 where the stored value account is for Starbucks coffee.
